(19) United States
(12) Patent Application Publication
(10) Pub. No.: US 2017/0068574 A1
(43) Pub. Date: Mar. 9, 2017

(54) MULTIPLE POOLS IN A MULTI-CORE SYSTEM

(71) Applicant: HEWLETT PACKARD ENTERPRISE DEVELOPMENT LP, Houston, TX (US)

(72) Inventors: Ludmila Cherkasova, Sunnyvale, CA (US); Feng Yan, Palo Alto, CA (US)

(21) Appl. No.: 15/120,958

(22) PCT Filed: Feb. 25, 2014
(86) PCT No.: PCT/US2014/018345

§ 371 Date: Aug. 23, 2016

(51) Int. Cl. G06F 9/50; G06F 9/48

(52) U.S. Cl. CPC G06F 9/5044; G06F 9/4881

(57) ABSTRACT

A system in accordance with an example includes a cluster and a scheduler engine coupled to the cluster. The cluster includes a plurality of nodes, wherein each node includes a faster core and a slower core and the plurality of nodes thereby includes a plurality of faster cores and a plurality of slower cores. The scheduler engine is to create a virtual fast pool and a virtual slow pool. The virtual fast pool includes the faster cores from the nodes and the virtual slow pool includes the slower cores from the nodes. Each faster core in the virtual fast pool is to process a job from a first job queue, and each slower core in the virtual slow pool is to process a job from a second job queue.

### BACKGROUND

“Hadoop” is an open-source software framework for storage and large scale data processing on clusters of homogenous computers. “MapReduce” is a programming model that may be used in Hadoop clusters for processing large data sets in parallel.

### BRIEF DESCRIPTION OF THE DRAWINGS

The present application may be more fully appreciated in connection with the following detailed description taken in conjunction with the accompanying drawings, in which like reference characters refer to like parts throughout, and in which:

FIG. 1 shows an example of virtual pools in a system on a chip (SoC) in accordance with an implementation;

FIG. 2 shows an example of a virtual shared pool in a system on a chip (SoC) in accordance with an implementation;

FIG. 3 shows a virtual pool generating engine in accordance with an implementation;

FIG. 4 shows a virtual shared pool generating engine in accordance with an implementation;

FIG. 5 shows a method to create virtual pools in accordance with an implementation; and

FIG. 6 shows a method to process a job by a virtual shared pool in accordance with an implementation.

### DETAILED DESCRIPTION

It is appreciated that certain terms are used throughout the following description and claims to refer to particular system components. As one skilled in the art will appreciate, technology companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .”Also, the term “couple” or “couples” is intended to mean either an indirect, direct, optical or wireless electrical connection. Thus, if a first device couples to a second device, that connection may be through a direct (wired or wireless) connection or through an indirect connection via other devices and connections.

The following discussion is generally directed to a job scheduler in a system that includes a multicore system. The multicore system described herein may be a heterogeneous multicore system meaning that the system includes at least two different types of cores. The job scheduler described herein takes advantage of the heterogeneous nature of the multicore system to more efficiently schedule and process jobs such as “MapReduce” jobs.

Data centers face diverse computing needs. Some jobs to be executed are time-sensitive meaning their completion deadline is mission critical. An example of a time-sensitive job is a job involving direct user interaction. If a user is directly interacting with software, the user is waiting for a response and the time lag for the software to provide the result should be as short as possible. Other jobs, such as batch processing jobs, may be less time-sensitive in that their completion deadline is not as critical as more time-sensitive jobs.

Systems that include homogenous processor cores (i.e., all processor cores being identical) may not be the most effective at processing largely diverse jobs. A system-on-a-chip (SoC) may include one or more multicore processors. All of the cores may be the highest speed cores available at the time of manufacture. Such cores may be beneficial for processing time-sensitive jobs. However, such high speed cores consume more power than lower speed cores. A given power budget for an SoC, therefore, limits the number of high speed cores that can be included on a given SoC. Consequently, an SoC with high speed cores may only be able to have relatively few of such cores. Conversely, an SoC may include lower speed cores. Such cores consume less power than their higher speed counterparts, thereby permitting an SoC to include a larger number of such lower speed cores for the same power budget. However, lower speed cores may not be satisfactory for processing time-sensitive jobs.

The SoC described herein includes heterogeneous multicore processors. A heterogeneous SoC includes two more different types of processor cores. For example, a heterogeneous SoC may include one or more higher speed cores better suited for processing time-sensitive jobs and one or more lower speed cores that can be used to process less time-sensitive batch jobs. As such, a heterogeneous SoC is more effective at meeting diverse computing needs. Because the lower speed cores are used to process the less time-sensitive batch jobs, the higher speed cores are made available to process the more time-sensitive jobs. A job scheduler is described below that schedules different types of jobs among the different types of processor cores accordingly.

As noted above, in one embodiment, the heterogeneous SoC may include two types of processor cores—one or more higher speed (e.g., higher performance) cores and one or more lower speed (e.g., lower performance) cores. Higher performance cores generally consume more power than lower performance cores, but execute jobs faster than lower performance cores. Other implementations of the SoC may have more than two different types of cores, for example, cores of slow, medium, and high speeds.

To offer diverse computing capabilities, the SoC described herein is heterogeneous meaning, as noted above, that it has a mix of higher and lower performance cores that execute the same instruction set while exhibiting different power and performance characteristics. A higher performance core operates at a higher frequency than a lower performance core, but also consumes more power than its lower performance core counterpart. Because lower performance cores consume less power than higher performance cores, for a given power budget, the SoC can include a larger number of lower power cores. Given that an SoC has a predetermined number of high performance cores and a predetermined number of low performance cores, the disclosed embodiments optimally utilize each group of cores. The principles discussed herein apply to a system that includes cores of different types, whether such cores are on one integrated SoC or provided as separate parts.

A scheduler engine is described herein. The scheduler engine permits the cores of a heterogeneous multi-core system to be virtually grouped based on their performance capabilities, with the higher performance (faster) cores included in one virtual pool and the lower performance (slower) cores included in a different virtual pool. As such, while all of the faster and slower cores may be physically provided on one SoC, cores of a common are grouped together by software. Such groupings are referred to as the “virtual” pools. As such, different types of jobs can be performed by different virtual pools of cores. For example, a first job type such as a completion-time sensitive job (e.g., a job in which a user is directly interacting with a machine) can be assigned to the virtual pool having faster cores, while a second job type such as a large batch job for which rapid completion time is less critical (e.g., a service-level job) can be assigned to the virtual pool having slower cores.

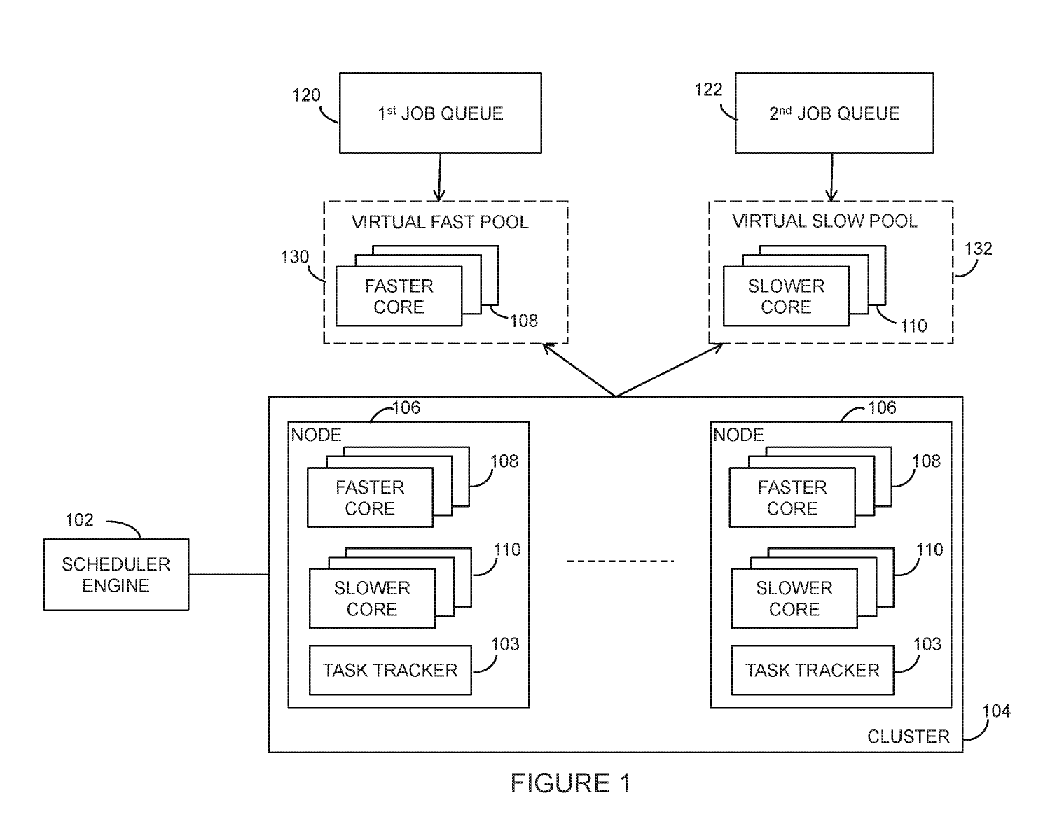

FIG. 1 shows an illustrative implementation of a cluster 104 of processor nodes 106. The cluster 104 itself may be an SoC, but can be other than an SoC in other implementations. Each node 106 includes one or more faster cores 108 and one or more slower cores 110. Each node may be a computing unit running its own instance of an operating system. In some implementations, each node may include a heterogeneous multi-core processor.

FIG. 1 also illustrates that groups of similar cores can be virtually combined to form a pool. The example of FIG. 1 illustrates two virtual pools 130 and 132. Virtual pool 130 includes the faster processor cores 108 (and is thus referred to as a “virtual fast pool”) and virtual pool 132 includes the slower processor cores from the cluster 104 (and is thus referred to as a “virtual slow pool”).

As shown in FIG. 1, a scheduler engine 102 is used to assign a job to be processed to one of the virtual pools 130 and 132 using data stored in the cluster 104 and to be processed by one or more jobs. The data may be stored and distributed across nodes 106 based on a file system such as, for example, a Hadoop Distributed File System (HDFS). Each of the nodes 106 can directly retrieve data from the file system. There may be at least two job queues to which a user may submit a job, for example, a first job queue 120 designated for completion-time sensitive jobs and a second job queue 122 for non-time sensitive jobs such as batch jobs. The scheduler engine 102 schedules and distributes jobs to the virtual pool 120 of faster cores 108 or the virtual pool 132 of slower cores 106 based on a user's designation. In some implementations, the designation may include a flag for the corresponding job. The flag may indicate whether the job is or is not time-sensitive. The scheduler engine 102 may receive the flag for the given job and cause the job to be assigned to the job queue in accordance with the flag.

The scheduler engine 102 may group some or all the faster cores 108 from the nodes 106 of the cluster 104 to create the virtual fast pool 130. Similarly, the scheduler engine 102 creates a virtual slow pool 132 to include some or all of the slower cores 110 from the nodes 106. In some implementations, the virtual fast pool 130 and virtual slow pool 132 are static, which means that, regardless of varying job queue requirements, the faster cores 108 and the slower cores 110 from each of the nodes 106 in the cluster 104 remain grouped into their respective virtual fast pool 130 and virtual slow pool 132.

While some or all faster cores 108 are included in the virtual fast pool 130, each of such cores may or may not be available—some faster cores may be available to process a job, while other faster cores in the virtual fast pool 130 are preoccupied currently processing a job and thus are unavailable. The same is true for the slower cores in the virtual slow pool 132—some of the slower cores in that pool may be available, while other slower cores are unavailable.

The first job queue 120 may be used to store jobs to be processed by the virtual fast pool 130 of faster cores 108, while the second job queue 122 may be used to store jobs to be processed by the virtual slow pool 132 of slower cores 110. A user may specify a particular job to be included into a designated job queue 120, 122. The scheduler engine 102 assigns one of the virtual pools 130, 132 to process a given job from the various job queues 120, 122. For example, if a user determines that a particular job is completion-time sensitive, the user may cause that job to be included into the first job queue 120. However, if the user considers a job not to be time sensitive (e.g., a batch job), the user may cause the job to be placed into the second job queue 122. The scheduler engine 102 causes the jobs from the first job queue 120 to be processed by the virtual fast pool 130 and jobs from the second job queue 122 to be processed by the virtual slow pool 132. Jobs are thus assigned to the virtual pools 130, 132 based on the job queues from which they originate.

In one example, the cluster 104 may store web server logs that track users' activities on various websites. It may be desirable to know how many times a particular word such as the word “Christmas” has been searched in the various websites during the past week. If the user determines this query is to be a time sensitive job, the user gives the job to the cluster 104 and includes the job in the first job queue 120 associated with the virtual fast pool 130. Upon the scheduler engine 102 recognizing that there is a new job in the first job queue 120, the scheduler engine 102 causes the job to be assigned to the virtual fast pool 130 to process the job.

Referring still to FIG. 1, the disclosed scheduler engine 102 may use a programming model that permits a user to specify a map function that processes input data to generate intermediate data in the form of <key, value> tuples. One suitable example of such a programming model is “MapReduce.” Intermediate data associated with a common key is grouped together and then passed to a reduce function. The reduce function merges the intermediate data associated with the common key to generate a new set of data values. A job specified by a user to be processed by one of the virtual pools 130, 132 is distributed and processed across multiple nodes 106 in the cluster 104.

A map stage (running the map function) is partitioned into map tasks, and a reduce stage (running the reduce function) is partitioned into reduce tasks. Each map task processes a logical split of data that is saved over nodes 106 in cluster 104. Data may be divided into uniformly-sized chunks and a default size of the chunk may be 64 MB. The map task reads the data, applies the user-defined map function on the read data, and buffers the resulting output as intermediate data. The reduce task applies the user-defined reduce function to process the intermediate data to generate output data such as an answer to a problem a user originally tries to solve. The scheduler engine 102 manages the nodes 106 in the cluster 104. Each node 106 may have a fixed number of map slots and reduce slots, which can run map tasks and reduce tasks, respectively. In some implementations, each of the faster cores 108 and slower cores 110 in the nodes 106 performs a map task and/or a reduce task. In one example, four slots may be available to be assigned by the scheduler engine 102 including a fast map slot, a fast reduce slot, a slow map slot and a slow reduce slot. The fast map slot may run the map task using the faster cores 108, and the slow reduce slot may run the reduce task using the slower cores 110.

Each of the nodes 106 in the cluster 104 includes a task tracker 103. The task tracker 103 in a given node is configured to do such operations as: monitor and report the availability of the faster cores and slower cores in the node to process a job, determine whether an available faster core may run a fast map task or a fast reduce task and whether an available slower core may run a slow map task or a slow reduce task, and send information regarding the cores' availability to the scheduler engine 102. Based on the cores' availability information from each of the task trackers 103, the scheduler engine 102 interacts with the first job queue 120 and the second job queue 122 to assign available faster cores 108 from the virtual fast pool 130 to process jobs in the first job queue 120, and to assign available slower cores 110 from the virtual slow pool 132 to process jobs in the second job queue 122.

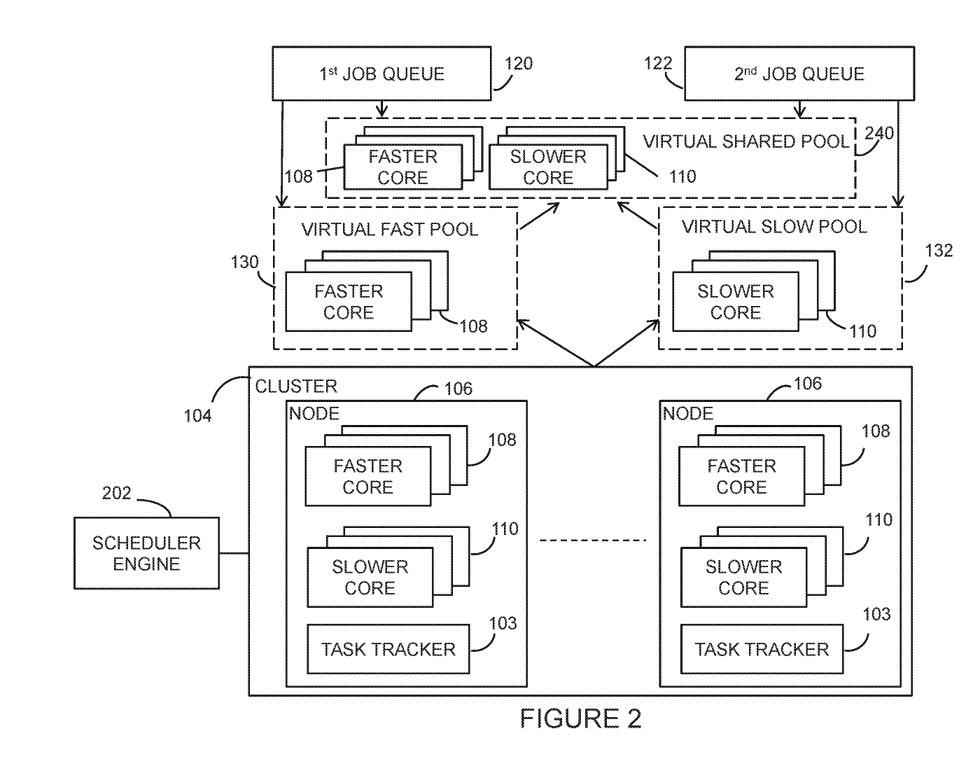

In some examples, the system may include a virtual shared pool of processor cores as is illustrated in FIG. 2. FIG. 2 is similar to FIG. 1, but also includes an example of a virtual shared pool 240 of processor cores.

In FIG. 2, the virtual shared pool 240 includes a plurality of faster cores 108 and slower cores 110 from each of the nodes in the cluster 104. In contrast with the static virtual fast and slow pools 130 and 132 created by the scheduler engine 102, the virtual shared pool 240 may be dynamic meaning that the shared pool may be created only when needed and then deactivated when one or more predetermined conditions necessitating its creation no longer exist, only to be created again at some point when a condition occurs that again warrants the shared pool. Various examples of predetermined conditions causing the scheduler engine to create shared pool 240 are provided below, but other conditions may be possible as well.

In one implementation, the virtual shared pool 240 is created by the scheduler engine 202 based on an unavailability of a faster core 108 or a slower core 110 in the virtual pools 130, 132 to process jobs from a dedicated job queue 120 and 122, respectively. For example, a job to be processed may be present in the first job queue 120 which is dedicated to be processed by the faster cores 108 in the virtual fast pool 130. However, due to an unavailability of any of the faster cores 108 in the virtual fast pool 130, the scheduler engine 202 may assign one or more of the slower cores 110 from the virtual slow pool 132 by way of the virtual shared pool created by the scheduler engine 102. As such, the faster cores 108 in the virtual shared pool 240 may include at least one of the faster cores 108 from the virtual fast pool 130 and at least one of the slower cores 110 from the virtual slow pool 132. In another example, while there is no job present in the second job queue 122, the scheduler engine 202 may add available slower cores 110 from the virtual slow pool 132 to the virtual shared pool 240 so that the slower cores 110 being added to the virtual shared pool 240 may be able to process a job in a first job queue,

Further, since the job queue requirement and the availabilities of the faster cores 108 and the slower cores 110 may change during runtime, the scheduler engine 202 may change the configuration of the virtual shared pool 240 dynamically. For example, a first job is present in the first job queue 120. Initially, the scheduler engine 202 detects whether an available faster core 108 exists in the virtual fast pool 130. If there is one present, the scheduler engine 202 assigns the job to be processed by the available faster core 108. However, if a faster core 108 is not available in the virtual fast pool 130, the scheduler engine 202 creates the virtual shared pool 240 to enable a slower core 110 from the virtual slow pool 132 to be added to the virtual shared pool 240, resulting in the slower core 110 (now in the virtual shared pool 240) to process the job in the first job queue.

Continuing with the above example, after the first job from the first job queue 120 is completed by the slower core 110 in the virtual shared pool, a second job may be placed in the first job queue 120 and a third job may be placed in the second job queue 122. The scheduler engine 202 may detect that a faster core 108 is now available in the virtual fast pool 130 and, if so, then the scheduler engine 202 may remove the slower core 110 from the virtual shared pool 240 back to the virtual slow pool 132. The second job from the first job queue 120 then may be processed the faster core 108 now available in the virtual fast pool 130. Further, the third job from the second job queue 122 may be processed by a slower core 110 in the virtual slow pool 132 (e.g., the slower core 110 just moved back from the virtual shared pool 240 to the virtual slow pool 132).

By creating the virtual shared pool 240, resources (e.g., faster cores 108 and slower cores 110) in the cluster 104 may be more efficiently utilized. Jobs in the first job queue 120 and the second job queue 122 can be processed by either a faster core 108 or a slower core 110 in the virtual shared pool 240. For example, a job in the first job queue 120 may be processed by an available slower core 110 in the virtual shared pool 240 until a faster core 108 becomes available (e.g., after completing its existing job), and similarly a job in the second job queue 122 may be processed by an available faster core 108 in the virtual shared pool 240 if no slower cores 110 are otherwise available.

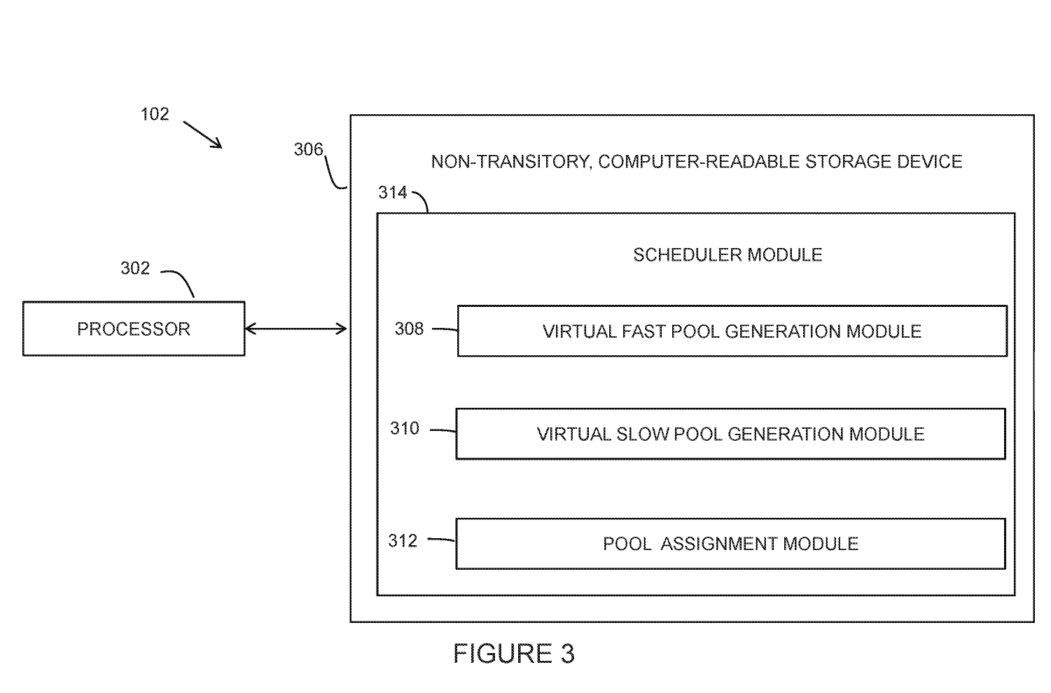

FIG. 3 shows a suitable example of an implementation of the scheduler engine 102 in which a processor 302 is coupled to a non-transitory, computer-readable storage device 306. The non-transitory, computer-readable storage device 306 may be implemented as volatile storage (e.g., random access memory), non-volatile storage (e.g., hard disk drive, optical storage, solid-state storage, etc.) or combinations of various types of volatile and/or non-volatile storage. The scheduler engine 102 is defined to be a processor (such as processor 302) executing the scheduler module 314. That is, the scheduler engine 102 is not only software.

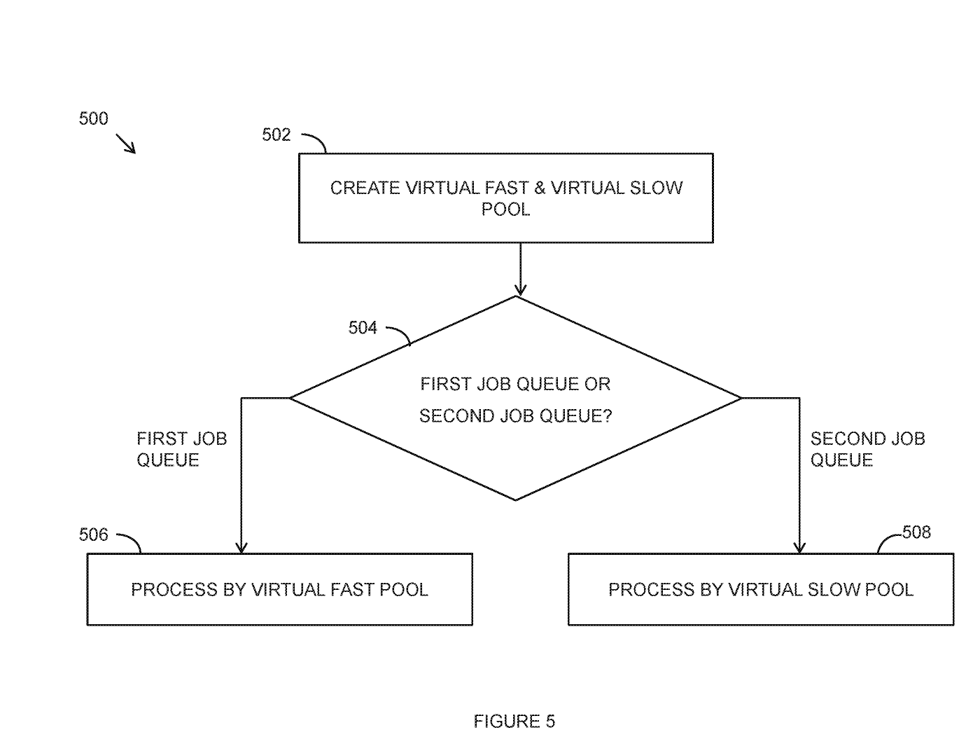

As shown in FIG. 3, the non-transitory, computer-readable storage device 306 includes a scheduler module 314, and the scheduler module 304 further includes a virtual fast pool generation module 308, a virtual slow pool generation module 310, and a pool assignment module 312. Each module of FIG. 3 may be executed by the processor 302 to implement the functionality described herein. The functions to be implemented by executing the modules 308, 310 and 312 will be described with reference to the flow diagrams of FIG. 5.

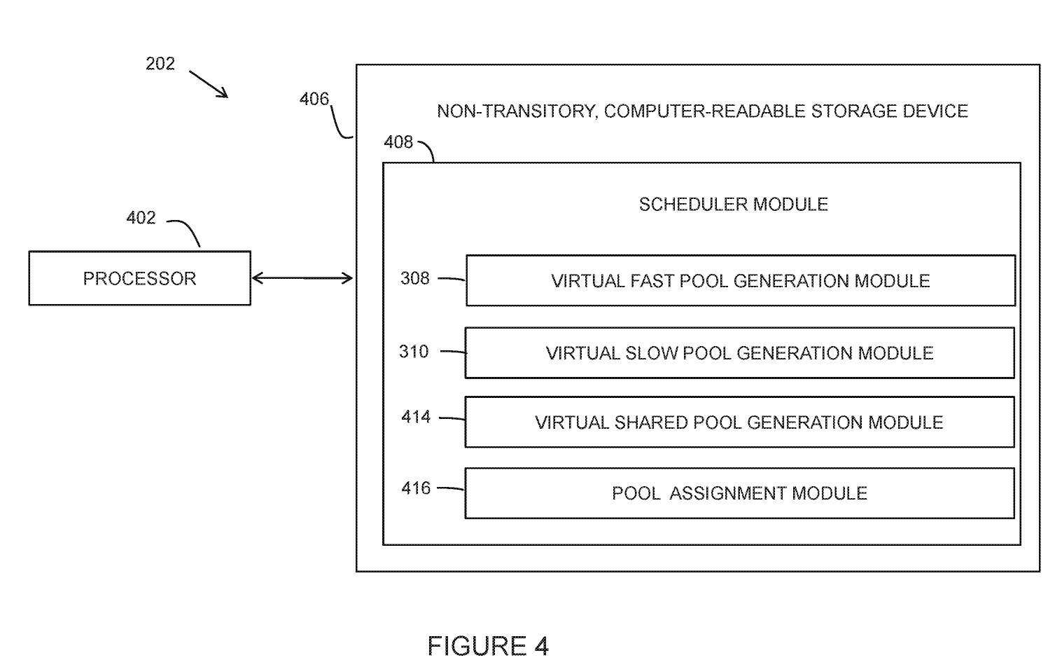

FIG. 4 shows an implementation of the scheduler engine 202 in the cluster 104 in which a processor 402 is coupled to a non-transitory, computer-readable storage device 406. The non-transitory, computer-readable storage device 406 may be implemented as volatile storage (e.g., random access memory), non-volatile storage (e.g., hard disk drive, optical storage, solid-state storage, etc.) or combinations of various types of volatile and/or non-volatile storage. The scheduler engine 202 is defined to be a processor (such as processor 402) executing the scheduler module 408. That is, the scheduler engine 202 is not only software.

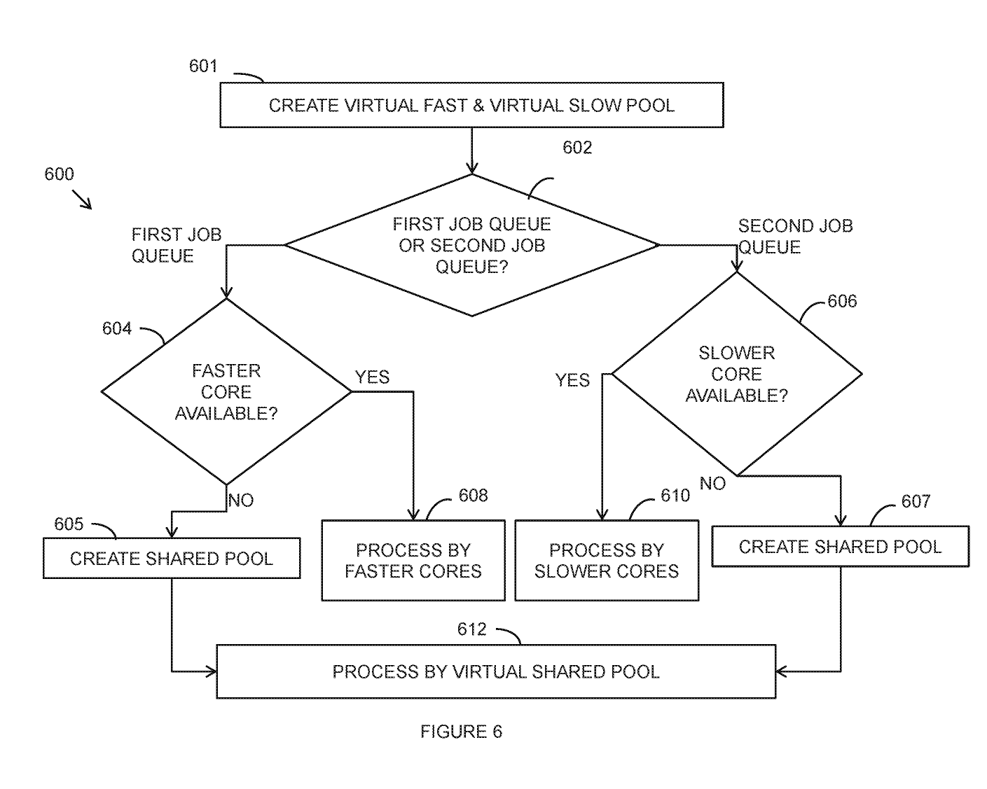

Referring to FIG. 4, in addition to a virtual fast pool generation module 308 and a virtual slow pool generation module 310 as described in FIG. 3, the scheduler module 408 includes a virtual shared pool generation module 414 and a pool assignment module 416. Each module of FIG. 4 may be executed by the processor 402 to implement the functionality described herein. The functions to be implemented by executing the modules 308, 310, 414 and 416 will be described with reference to the flow diagrams of FIG. 6.

FIG. 5 shows a flow diagram for an illustrative method 500 implemented by, for example, the scheduler engine 102 in accordance with various implementations. As a result of executing the virtual fast pool generation module 308 and the virtual slow pool generation module 310 by the processor 302, the method 500 begins at block 502. In block 502, the scheduler engine 102 creates the virtual fast pool 130 and the virtual slow pool 132, based on an initial configuration of the cluster 104, for example, a Hadoop cluster. In some implementations, the initial configuration, including information of how many faster cores 108 and slower cores 110 in each of the node 106, may be hard-coded into the scheduler engine 102. The virtual fast pool 130 includes the faster cores 108 from each of the nodes 106 in the cluster 104; the virtual slow pool 132 includes the slower cores 110 from each of the nodes 106 in the cluster 104.

At block 504, the scheduler engine 102, based on a user's decision, determines whether a job to be processed is in the first job queue 120 or in the second job queue 122. In some examples, the first job queue 120 may be a time sensitive job queue (e.g., for interactive jobs) and the second job queue 122 may be a non-time sensitive job queue (e.g., for batch jobs. Further, a user who requests the job may specify (e.g., by way of a flag as noted above) the job queue in which the job is to be placed.

The method 500 continues at block 506 and block 508 with executing the pool assignment module 312 to cause the scheduler engine 102 to choose which virtual pool should be used to process a job. If the scheduler engine 102 determines the presence of a job in the first job queue, at 506, the scheduler engine 102 assigns the faster cores 108 in the virtual fast pool 130 to process the job. Analogously, if the scheduler engine 102 determines the presence of a job in the second job queue, at 508, the scheduler engine 102 uses the slower cores 110 in the virtual slow 132 pool to process the job.

FIG. 6 shows a flow diagram for a method 600 implemented by the scheduler engine 202 in accordance with various implementations. The method 600 starts at block 601 in which, as explained above, the scheduler engine 102 creates the virtual fast pool 130 and the virtual slow pool 132 based on an initial configuration of the cluster 104. For example, the virtual fast pool generation module 308 executed by the processor 402 may be used to create the pools. At block 602, the scheduler engine 202 detects whether a job is in a first job queue 120 or in a second job queue 122.

If the job is in the first job queue, the method 600 continues at block 604 to cause the scheduler engine 202 to determine whether a faster core 108 is available in a virtual fast pool 130. if a faster core 108 in the virtual fast pool 130 is available, the method 600 continues at block 608 with processing the job by the faster cores 108 in the virtual fast pool 130. However, if the scheduler engine 202 determines that a faster core 108 in the virtual fast pool 130 is not available, the processor 402 executes the virtual shared pool generation module 414 to create a virtual shared pool 240 (block 605) and to process the job by the virtual shared pool (612).

Returning to block 602, if the job is specified in the second job queue, the method 600 continues at block 606 to cause the scheduler engine 202 to determine whether a slower core 110 is available in the virtual slow pool 132. Similarly, if a slower core 110 in the virtual slow pool 132 is available, the method 600 continues at block 610 with processing the job by a slower core 110 in the virtual slow pool 132. However, if the scheduler engine 202 determines that a slower core 110 in the virtual slow pool 132 is not available, the processor 402 executes the virtual shared pool generation module 414 to create a virtual shared pool 240 (block 607) and to process the job by the virtual shared pool (612).

In some implementations, the virtual shared pool 240 includes all of the available (if any) faster cores 108 and all of the available (if any) slower cores 110 from the virtual fast pool 130 and the virtual slow pool 132.

The above discussion is meant to be illustrative of the principles and various embodiments of the present disclosure. Numerous variations and modifications will become apparent to those skilled in the art once the above disclosure is fully appreciated, It is intended that the following claims be interpreted to embrace all such variations and modifications.

What is claimed is:

1. A system, comprising:
a cluster comprising a plurality of nodes, wherein each node comprises a faster core and a slower core, the plurality of nodes thereby including a plurality of faster cores and a plurality of slower cores; and
a scheduler engine coupled to the cluster, the scheduler engine is to create a virtual fast pool including the faster cores from the nodes and a virtual slow pool including the slower cores from the nodes;
wherein each faster core in the virtual fast pool is to process a job from a first job queue, and each slower core in the virtual slow pool is to process a job from a second job queue.

2. The system of claim 1, wherein the scheduler engine is further to create a virtual shared pool including at least one of a faster core and a slower core from the respective virtual fast and slow pools, wherein a slower core in the virtual shared pool is to process a first job from the first job queue based on an unavailability of a faster core in the virtual fast pool, and a faster core in the virtual shared pool is to process a second job from the second job queue based on an unavailability of a slower core from the virtual slow pool.

3. The system of claim 2 wherein each node includes a task tracker to:
monitor an availability of the faster and slower cores in the corresponding node; and
send availability information regarding the cores' availability to the scheduler engine.

4. The system of claim 3 wherein the scheduler engine, based on the availability information received from the task tracker, is to create the virtual shared pool.

5. The system of claim 1 wherein the first job queue is an interactive job queue and the second job queue is a batch job queue.

6. The system of claim 1 wherein the cluster includes a system on a chip (SoC).

7. The system of claim 1 wherein at least one of the faster cores and at least one of the slower cores are to perform at least one of a map task and a reduce task.

8. A non-transitory, computer readable storage device containing instructions that, when executed by a processor, cause the processor to:
create a virtual fast pool including a plurality of faster cores from a plurality of nodes in a cluster;
create a virtual slow pool including a plurality of slower cores from the plurality of nodes in the cluster;
assign a job from a first job queue to be processed by a faster core in the virtual fast pool; and
assign a job from a second job queue to be processed by a slower core in the virtual slow pool.

9. The non-transitory, computer readable storage device of claim 8 wherein the instructions further cause the processor to:
create a virtual shared pool comprising at least one of a faster core and a slower core from the respective virtual fast and slow pools based on a predetermined condition being detected regarding availability of the cores;
if a first job is present in the first job queue, assign the first job to be processed by a slower core in the virtual shared pool instead of the virtual fast pool; and
if a second job is present in the first job queue, assign the second job to be processed by the faster core in the virtual shared pool instead of the virtual slow pool.

10. The non-transitory, computer readable storage device of claim 8 wherein the instructions cause the processor to deactivate the virtual shared pool when the predetermined condition no longer exists.

11. The non-transitory, computer readable storage device of claim 8 wherein the instructions cause the processor to receive availability information for the faster and slower cores in each of the node.

12. The non-transitory, computer readable storage device of claim 11 wherein a scheduler engine creates a virtual shared pool of at least one core based on the availability information indicating that at last one of the following conditions is true:
none of the faster cores in the nodes are available; and
none of slower cores in the nodes are available.

13. A method, comprising:
creating, by a scheduler engine, a virtual fast pool and a virtual slow pool wherein the virtual fast pool includes a plurality of faster cores from a plurality of nodes in a cluster and the virtual slow pool includes a plurality of slower cores from the plurality of nodes in the cluster;
determining whether a job is present in a first job queue or a second job queue;
if a job is present in the first job queue, processing the job by the virtual fast pool; and
if a job is present in the second job queue, processing the job by the virtual slow pool.

14. The method of claim 13, further comprising:
detecting whether a predetermined condition is true;
if the predetermined condition is true, creating a virtual shared pool including a core from at least one of virtual fast pool and the virtual slow pool.

15. The method of claim 14 wherein the predetermined condition includes unavailability of all faster cores in the virtual fast pool or unavailability of all slower cores in the virtual slow pool and wherein creating the virtual shared pool includes including a slower core from the virtual slow pool if no faster core is available and creating the virtual shared pool includes including a faster core from the virtual fast pool if no slower core is available.
